(19) United States
(12) Patent Application Publication
(10) Pub. No.: US 2001/0027920 A1
(43) Pub. Date: Oct. 11, 2001

(54) Device and method for manipulation of an electrophoresis gel

(75) Inventors: N. Leigh Anderson, Washington, DC (US); Jack Goodman, Lusby, MD (US); Andrew McGrath, Burtonsville, MD (US)

Correspondence Address: ROYLANCE, ABRAMS, BERRO & GOODMAN, L.L.P., 1300 19TH STREET, N.W., SUITE 600, WASHINGTON,, DC, 20036, US

(73) Assignee: Large Scale Proteomics Corp.

(21) Appl. No.: 09/783,136

(22) Filed: Feb. 15, 2001

Related U.S. Application Data
(63) Continuation-in-part of application No. 09/504,493, filed on Feb. 15, 2000.
(63) Continuation-in-part of application No. 09/504,494, filed on Feb. 15, 2000.

(51) Int. Cl. G01N 27/26

(52) U.S. Cl. 204/462; 204/613; 220/608; 269/238

(57) ABSTRACT

A method and device for transferring an electrophoresis gel from a cassette to a carrier includes a tray having a dimension to receive a cassette and a carrier device. The tray has a bottom wall with a surface with channels or recesses formed by projections to reduce contact of an electrophoresis gel with the bottom wall of the tray. The projections are typically pyramid-shaped members extending to a peak having a small surface area to prevent the electrophoresis gel from adhering to the bottom wall. The bottom wall also includes a recessed area to receive the carrier so that the gel can slide easily from the cassette to open jaws of the carrier. A retaining arm extends from a side wall of the tray to hold the jaws of the carrier in an open position while the gel is being positioned between the clamping surfaces of the jaws.

### CROSS-REFERENCE TO RELATED APPLICATION

This application is a continuation-in-part application of prior U.S. application Ser. No. 09/504,493, filed Feb. 15, 2000, and Ser. No. 09/504,494, filed Feb. 15, 2000, which are hereby incorporated by reference in their entirety.

### FIELD OF THE INVENTION

The present invention is directed to a device such as a tray for use in manipulating a electrophoresis gel. More particularly, the invention is directed to a device and method for transferring an electrophoresis gel from a cassette to a manipulating carrier device for use in processing the gel.

### BACKGROUND OF THE INVENTION

Isoelectric focusing (IEF) is an electrophoretic technique that is commonly used for the analysis, separation and purification of various biological materials, and particularly proteins. Since many of the complex molecules of biological interest are amphoteric in nature, they are typically amenable to IEF separation.

The separation of macromolecules, and particularly proteins, often is carried out by two-dimensional electrophoresis separation. The two-dimensional electrophoresis separation typically involves the sequential separation by isoelectric focusing of a sample in a gel tube followed by slab gel electrophoresis. The isoelectric focusing process in the gel tube is often referred to as first dimension separation.

In the first dimension separation, an isoelectric focusing gel, such as acrylamide, is placed or polymerized in a tube. The open ends of the tube are positioned in a tank with a buffer solution at each end of the tube. One end of the tube is positioned in a bath of a buffer solution such as sodium hydroxide solution. The other end of the tube is positioned in a bath of a second buffer solution such as a phosphoric acid solution. An electric current is applied to the two buffer solutions. The current together with ampholytes incorporated into the gel composition or titratable gel monomers incorporated into the gel, provides a pH gradient through the gel along the length of the tube. The sample to be analyzed is applied to a one end of the gel in the tube and an electric current is applied to an electrode in each of the buffer solutions. The molecules in the sample migrate through the gel under the influence of the electric potential until they reach their respective isoelectric point.

Slab gel electrophoresis, often referred to as second dimension separation, utilizes an electrophoresis gel molded between two glass plates. A gel strip or cylinder in which the protein sample has been resolved by the first dimension isoelectric focusing is placed along one edge of the slab gel. The ends of the gel slab are positioned in a buffer solution and an electric current is applied to each end of the gel. The proteins are then allowed to migrate through the gel slab under an applied voltage.

Charged detergents, such as sodium diodecyl sulfate, contained in the slab gel bind to the protein molecules. The detergents tend to unfold the protein molecules into rods having a length proportional to the length of the polypeptide chain and thus proportional to the molecular weight of the polypeptide. A protein complexed with a charged detergent is highly charged, which causes the protein-detergent complex to move in an applied electric field. When the slab gel, such as a polyacrylamide gel, functions as a sieve, the movement of the longer and higher molecular weight molecules is retarded compared to the shorter, lower molecular weight molecules.

Electrophoresis separation is generally labor intensive since numerous samples are run simultaneously. Generally, the gel tubes are prepared and placed in a suitable tank of buffer solutions. The protein samples are then manually placed on the end of a gel tube. When hundreds of protein samples are prepared daily for isoelectric focusing, the manual steps significantly increase the time requirements for performing the first dimension separation.

The resolution of the separation methods are sufficient to separate at least 150 proteins from a mixture. The first dimension isoelectric focusing separation followed by the second dimension SDS electrophoresis separation can result in the resolution of as many as 22,000 proteins from a single sample. A critical step in obtaining high resolution two-dimensional electrophoresis is to coordinate the first dimension separation with the second dimension separation.

The gel slab is removed from the glass plates and immersed in a series of baths containing various staining agents. Typically, the gel slabs are manually transferred from a stain bath to various fixing solutions and rinsing solutions. After the second dimension electrophoresis separation, the gel is developed to stain the proteins which appear as a spot on the gel. Thereafter, a gel spot can be identified, removed from the slab, and analyzed.

The gel slabs are made of a flexible gel and care must be taken to prevent damaging or tearing the gel. During handling and manipulating, the gel slab adheres to surfaces that it contacts. As the gel is pulled from the surface, the gel can tear or stretch. Various devices have been proposed for handling and manipulating gel slabs. However, these devices have experienced only limited success. Accordingly, there is a continuing need in the industry for improved methods and devices for handling electrophoresis gels.

### SUMMARY OF THE INVENTION

The present invention is directed to a method and device for manipulating an electrophoresis gel slab. More particularly, the invention is directed to a method and device for transferring an electrophoresis gel from a cassette to a manipulating device.

Accordingly, a primary aspect of the invention is to provide a method and device for separating an electrophoresis gel slab from a second dimension electrophoresis gel cassette without damaging the gel.

Another aspect of the invention is to provide a vessel for transferring an electrophoresis gel slab from a plate to a carrier device where the vessel has a surface that inhibits the gel from adhering to the surface of the vessel.

A further aspect of the invention is to provide a device for transferring an electrophoresis gel slab from a plate to a clip for manipulating the gel slab.

Another aspect of the invention is to provide a device for manipulating an electrophoresis gel, where the device has at least one surface that forms a liquid barrier between the gel and the surface to resist the gel from adhering to the surface.

Still another aspect of the invention is to provide a tray for transferring a gel slab from a second dimension electrophoresis cassette to a manipulating device where the tray has a bottom surface with a plurality of projections having a limited surface area to limit contact of the gel with the bottom surface.

A further aspect of the invention is to provide a tray having a bottom wall with a plurality of substantially pyramid shaped projections to provide a sufficiently small area of contact with an electrophoresis gel to inhibit the gel from adhering to the bottom wall.

A further aspect of the invention is to provide a method of transferring an electrophoresis gel from a cassette to a carrier device by immersing the cassette and the carrier in a liquid and sliding the gel from the cassette into coupling engagement with the carrier. The liquid can be contained in a vessel having a surface that resists the gel from adhering to the vessel.

Another aspect of the invention is to provide a tray that is dimensioned to receive an electrophoresis gel slab cassette and a carrier device where the gel slab can be transferred readily to the carrier.

Still another aspect of the invention is to provide a tray for transferring a gel slab from a cassette to a carrier, where the tray has a bottom wall with a recess dimensioned to receive the carrier to assist in the transfer of the gel to the carrier.

A further aspect of the invention is to provide a tray for transferring an electrophoresis gel from a cassette to a carrier having a pair of jaws and where the tray includes an arm for holding the jaws in an open position.

Another aspect of the invention is to provide a vessel with an inner surface having a plurality of recesses to form fluid channels, where the channels have a dimension to allow fluid to flow between a substrate in contact with the surface to inhibit the substrate from adhering to the surface.

Still another aspect of the invention is to provide a device for manipulating an electrophoresis gel where the device has a surface with fluid inlets for supplying a liquid between the device and the gel.

The aspects of the invention are basically attained by providing a vessel for transferring an electrophoresis gel from a cassette to a carrier for the gel, where the vessel includes a bottom wall having a top face with a plurality of upwardly extending projections having a surface area to limit contact of an electrophoresis gel slab with the bottom. The vessel also includes a side wall coupled to the bottom wall defining an interior region of the tray.

The aspects of the invention are also attained by providing in combination a vessel having a bottom wall and a side wall and a clamp assembly. The vessel has a dimension to receive a second dimension electrophoresis gel cassette and the clamp assembly. The clamp assembly has a pair of movable jaws having an operating end and a gripping end where the gripping ends are biased toward each other. The vessel includes a movable retaining arm to hold the clamp assembly in an open position.

The aspects of the invention are further attained by providing a method of transferring an electrophoresis gel from a cassette to a carrier. The method basically comprises the steps of positioning an electrophoresis gel cassette and a carrier in a liquid bath contained in a tray. The tray has a bottom wall with a plurality of projections forming channels between adjacent projections. The channels are dimensioned to allow the liquid to flow between the gel and the bottom wall. The gel in the cassette is moved from the cassette to the carrier.

The objects, advantages and salient features of the invention will become apparent to one skilled in the art in view of the following detailed description of the invention in conjunction with the annexed drawings which form a part of this original disclosure.

### BRIEF DESCRIPTION OF THE DRAWINGS

The following is a brief description of the drawings, in which:

FIG. 1 is a perspective view of the vessel in a first embodiment of the invention showing the bottom surface and the retaining arm in a retracted position;

FIG. 2 is a partial top view of the bottom surface of the vessel of FIG. 1;

FIG. 3 is a partial cross-sectional view of the bottom wall of the vessel taken along line 3-3 of FIG. 2;

FIG. 3A is a cross-sectional view of an alternative embodiment of the surface of the tray;

FIG. 3B is a perspective view of another embodiment of the surface of the tray;

FIG. 4 is a perspective view of the vessel of FIG. 1 showing the carrier clip positioned in a recess in the bottom wall of the vessel of FIG. 1;

FIG. 5 is a perspective view of the vessel of FIG. 1 showing the retaining arm holding the carrier clip in the open position;

FIG. 6 is a cross-sectional side view of the vessel, carrier clip and gel cassette;

FIG. 7 is a cross-sectional side view of the vessel showing the gel cassette and carrier positioned in the vessel;

FIG. 8 is a cross-sectional side view of the vessel showing the gel slab positioned between the jaws of the carrier clip;

FIG. 9 is a front view of the carrier clip and gel coupled to an automated robotic arm for manipulating the gel;

FIG. 10 is a partial perspective view of a support surface for manipulating a gel in another embodiment of the invention; and

FIG. 11 is a partial side view in cross-section of support surface of FIG. 10.

### DETAILED DESCRIPTION OF THE INVENTION

The present invention is directed to a device for manipulating an electrophoresis gel from a cassette. More particularly, the invention is directed to a method and device for separating electrophoresis gel from a cassette and transferring the gel to a carrier device without damaging the gel.

Electrophoresis separation of proteins and other macromolecules generally uses a two-dimensional separation. In the first dimension separation step, a biological sample is placed at one end of a cylindrical tube containing an electrophoresis gel. Each end of the tube is contacted with a buffer solution. An electrical potential is applied between opposite ends of the tube to cause the macromolecules to migrate through the electrophoresis gel until they reach their respective isoelectric point. The gel from the first dimension electrophoresis separation is transferred to one end of an electrophoresis gel slab supported between two sheets of glass. An electric potential is applied between opposite ends of the gel slab to cause the macromolecules to migrate through the electrophoresis gel.

The electrophoresis gel slab from the second dimension electrophoresis separation is separated from the glass plates. The gel is then treated with various staining solutions to stain the separated proteins and macromolecules. Gel spots containing the stained proteins and macromolecules are then cut from the gel slab for further analysis.

The gel slabs can be difficult to separate from the glass plates. The gel can tear easily when the gel adheres to the glass plates. A primary aspect of the present invention is to provide a method and device for separating an electrophoresis gel slab from a cassette and to transfer the electrophoresis gel slab to a carrier device to assist in moving the gel slab through the various processing steps.

Referring to the drawings, the invention is directed to an assembly 10 including a device having a surface that inhibits the gel from adhering to the device. In a preferred embodiment of the invention, assembly 10 includes a vessel such as a tray 12 and a retaining arm 14 coupled to tray 12. In the embodiment illustrated, tray 12 has a substantially rectangular configuration with a bottom wall 16, side walls 18 and end walls 20. Side walls 18 and end walls 20 extend in a substantially upward direction perpendicular to bottom wall 16 to define an internal cavity 22. Typically, tray 12 has an open top.

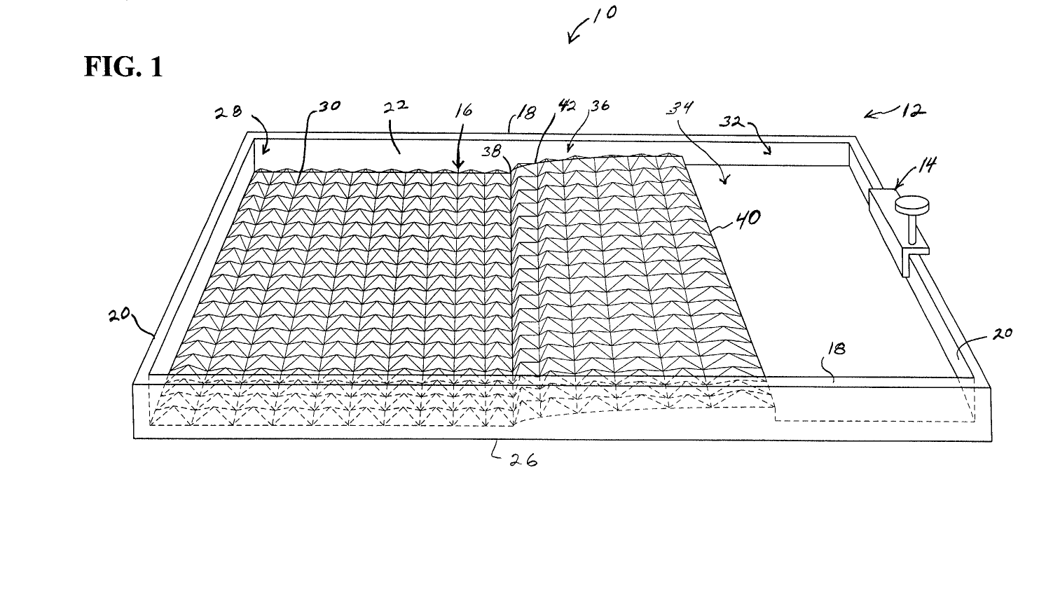

As shown in FIGS. 1 and 4, bottom wall 16 has a top face 24 and a bottom face 26. Bottom face 26 is substantially planar and defines a horizontal dimension of tray 12. Top face 24 includes a first end 28 having a first bottom section 30. A second end 32 of top face 24 is provided with a second bottom section 34. As shown in the embodiment of FIG. 1, a substantially inclined middle section 36 extends between first bottom section 30 and second bottom section 34. In alternative embodiments, tray 12 can have a substantially flat bottom extending between first end 28 and second end 32.

First bottom section 30 of bottom wall 16 forms a substantially planar surface and an area of tray 12 having a substantially uniform depth. Inclined middle section 36 is contiguous with first bottom section 30 to form an area of tray 12 having a decreasing depth from first end 28 toward second end 32. As shown in FIG. 1, inclined middle section 36 has a first end 38 joining first bottom section 30 and a second end 40 opposite first end 38. Second bottom section 34 is recessed with respect to second end 40 of inclined middle section 36. Second bottom section 34 has a substantially planar bottom surface extending between side walls 18 and end wall 20 at second end 32.

In preferred embodiments of the invention, inclined middle section 36 has a top surface 42 that resists an electrophoresis gel from adhering to bottom wall 16. In the embodiment illustrated, first bottom section 30 also includes a top surface that resists adhering to an electrophoresis gel.

In one embodiment of the invention, top surface 42 of inclined middle section and the top surface of first bottom section 30 has a surface that is able to support a liquid barrier layer between the gel and the surfaces of assembly 10. In the illustrated embodiment, the surfaces include a plurality of fluid channels 52 formed by spaced-apart projections 46. Projections 46 are spaced-apart to form a plurality of rows and columns to form a substantially uniform array. Projections 46 in the illustrated embodiment have a substantially pyramid shape formed by outer faces 48 that converge to a peak 50. Projections 46 form channels 52 between adjacent peaks 50, which appear as a recess or trough. Projections 46 are dimensioned so that peaks 50 support an electrophoresis gel slab without damaging the gel slab as discussed hereinafter in greater detail. Peaks 50 have a dimension to form a contact area for contacting the gel that is less than the surface area of top surface 42. Projections 46 are spaced apart a distance and provide a surface area sufficient to support an electrophoresis gel without piercing or damaging the gel. The spacing between adjacent peaks preferably prevents the gel from contacting the bottom of channels 52. Channels 52 have a width and depth sufficient to contain a volume of liquid and to form channels between peaks 50 to enable a liquid to flow between peaks 50 and prevent an electrophoresis gel from adhering to projections 46.

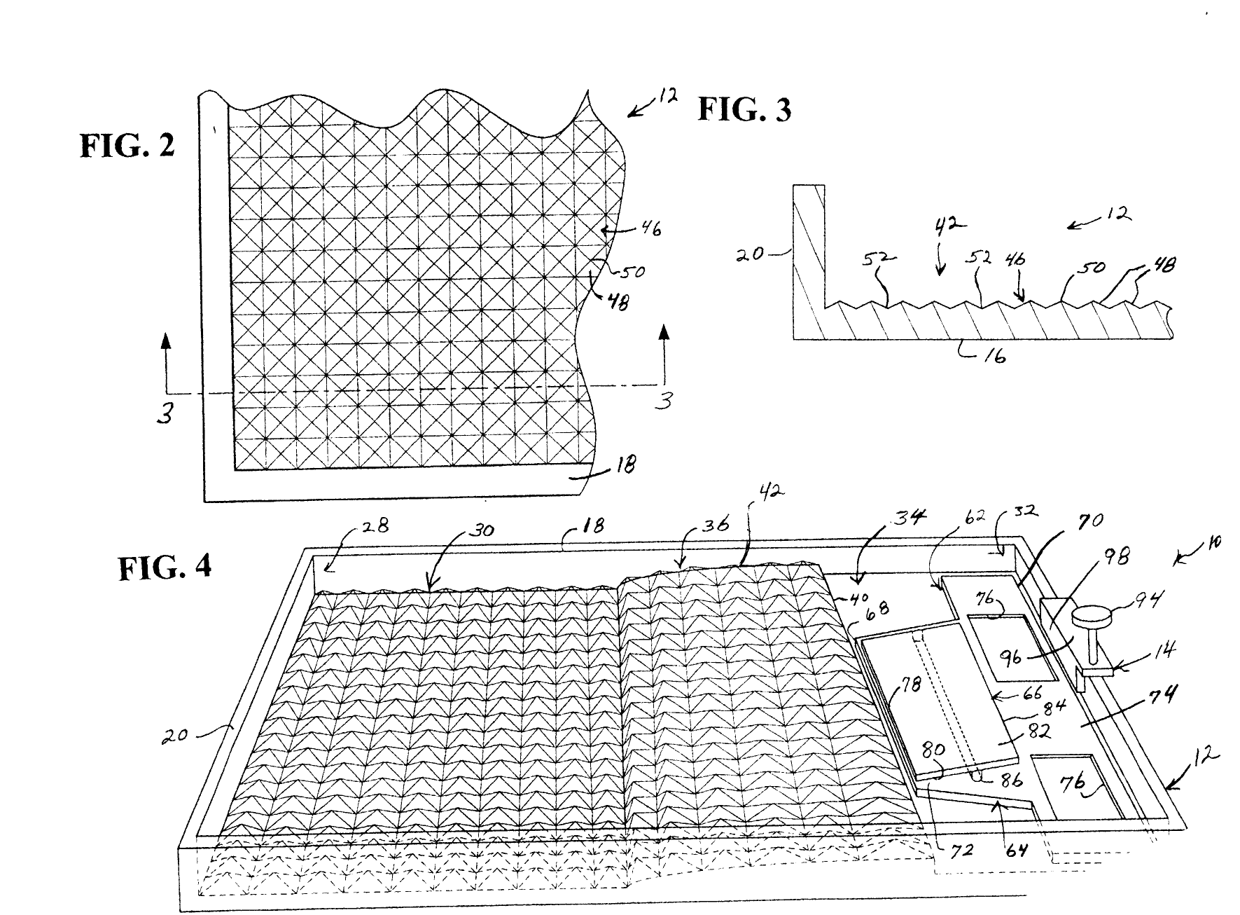

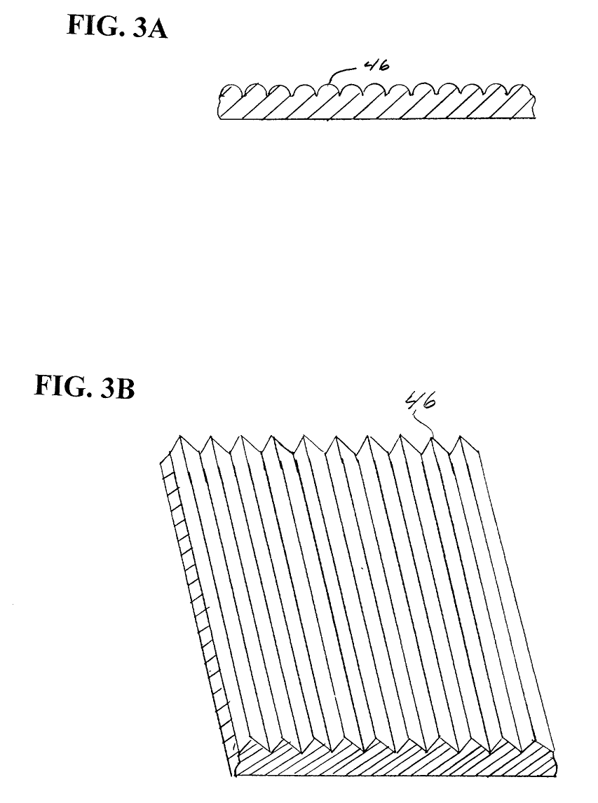

In the embodiment illustrated in FIGS. 1-3, projections 46 have substantially planar outer faces 48. In alternative embodiments, the projections can be formed with concave surfaces or convex surfaces resembling a bubbled surface as shown in FIG. 3A. In further embodiments, the projections can be in the form of spaced-apart ridges forming valleys between adjacent peaks as shown in FIG. 3B. The ridges can be oriented in a longitudinal direction, transverse direction or diagonal direction with respect to a longitudinal dimension of tray 12. In further embodiments, the surfaces of tray 12 can be formed with a series of recesses or channels that do not define distinct projections as in the illustrated embodiment.

In the illustrated embodiment of tray 12, projections 46 provide a surface that inhibits the gel slab from adhering to the bottom of tray 12. The electrophoresis gels as commonly used in the art are soft and pliable. Moreover, the gels generally have a tacky surface that tend to stick to various surfaces on contact. The pliable nature of the gels enable the gels to stick readily to smooth surfaces such as a glass plate or the smooth surface of a tray or tank. It has been found that forming the surface with a plurality of channels, recesses or apertures reduce the surface area that contacts the gel, thereby inhibiting the gel from sticking. In addition, the channels provide a system to release the suction between the gel and the surface of the tray that occurs when the gel is pulled away from the surface. The channels can be of any number of shapes and orientations that are able to release the suction or prevent the suction from forming. Preferably, the channels have a dimension and length to allow a fluid, such as distilled water or a buffer solution to flow between the gel and the surface of tray 12 to release the suction effect and inhibit the gel from adhering to the surface.

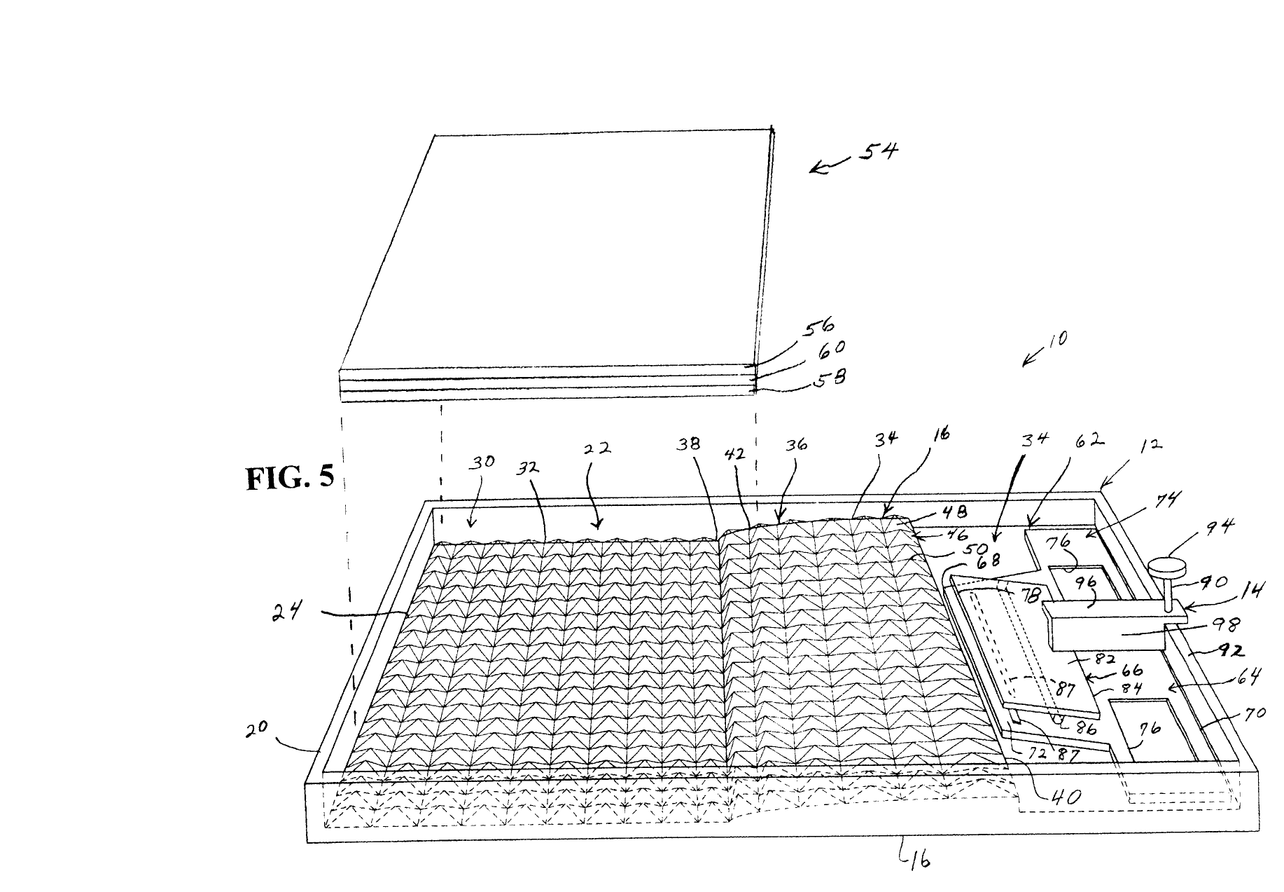

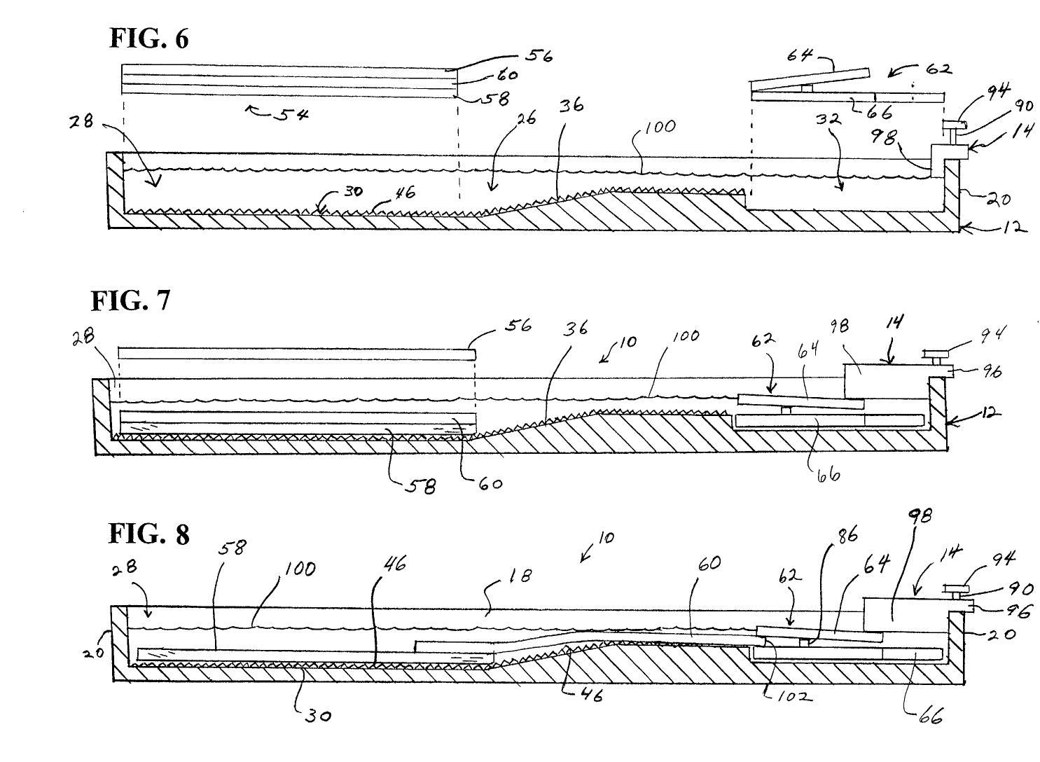

As shown in FIGS. 5 and 6, first bottom section 30 has a dimension corresponding substantially to an electrophoresis gel cassette 54. Cassette 54 is a standard second dimension electrophoresis cassette as known in the electrophoresis art. Cassette 54 includes a first supporting plate 56 and a second supporting plate 58 spaced-apart a uniform distance by spacers (not shown). Plates 56 and 58 are typically glass plates, although other materials can be used. An electrophoresis gel 60 is provided between plates 56 and 58. Typically, gel 60 has a thickness of about 2-3 mm.

Assembly 10 is particularly suitable for use in conjunction with a carrier 62 capable of supporting an electrophoresis gel slab. In one embodiment of the invention, carrier 62 is a clip having a first and second clamping jaws 64 and 66. First clamping jaw 64 has a substantially planar configuration with a bottom edge 68 and a top edge 70. Bottom edge 68 has a substantially straight edge defining a clamping surface 72 for gripping an electrophoresis gel. Top edge 72 defines an operating end 74 of first clamping jaw 64. Operating end 74 of first clamping jaw 64 in one embodiment includes two spaced-apart apertures 76 for coupling to a robotic arm as discussed hereinafter in greater detail.

Second clamping jaw 66 has a bottom edge 78 complementing bottom edge 68 of first clamping jaw 64. Bottom edge 78 defines a clamping surface 80 complementing clamping surface 72 of first clamping jaw 64. Second clamping jaw 66 has an operating end 82 along a top edge 84. As shown in FIGS. 4 and 5, second clamping jaw 66 has a longitudinal length complementing bottom edge 68 of first clamping jaw 64 and a width less than the width of first clamping jaw 64. In alternative embodiments, first clamping jaw 64 and second clamping jaw 66 can be substantially the same size.

A ridge 86 is coupled to second clamping jaw 66 and extends in a longitudinal direction between bottom edge 78 and top edge 84. In the embodiment illustrated, ridge 86 is positioned at a midpoint between bottom edge 78 and top edge 84. Ridge 86 extends substantially parallel to bottom edge 78 and forms a fulcrum to enable second clamping jaw 66 to pivot about ridge 86 with respect to first clamping jaw 64 to open and close clamping surfaces 72 and 80 of first clamping jaw 64 and second clamping jaw 66, respectively. In a preferred embodiment, first clamping jaw 64 and second clamping jaw 66 include magnets 87 to bias the clamping ends together as shown in FIG. 5. Typically, magnets 87 are flexible, plastic magnetic strips attached to the inner faces of the jaws and are oriented to attract each other. In alternative embodiments, other biasing devices can be used.

Referring to FIG. 6, second bottom section 34 of bottom wall 16 of tray 12 is dimensioned to receive first clamping jaw 64. As shown in FIG. 7, second bottom section 34 is recessed with respect to top surface 36 a distance corresponding substantially to the thickness of first clamping jaw 64. In this fashion, clamping surface 72 of first clamping jaw 64 is substantially coplanar with top surface 42.

In a preferred embodiment, tray 12 is provided with retaining arm 14 for engaging operating end 82 of second clamping jaw 66 and retaining clamping surfaces 72 and 80 in an open position. Retaining arm 14 in one preferred embodiment of the invention is connected to end wall 20 by a pivot pin 90. Pivot pin 90 is fixed to retaining arm 14 and extends into an aperture in a top surface 92 of end wall 20. A knob 94 is connected to a top end of pivot pin 90 for rotating retaining arm 14 from a retracted position shown in FIG. 4 to a retaining position shown in FIG. 5.

Retaining arm 14 in the embodiment illustrated has a generally L-shape configuration with a substantially horizontal leg 96 and a downwardly extending vertical leg 98. Vertical leg 98 has a dimension to engage operating end 82 of second clamping jaw 66 as shown in FIG. 5. Retaining arm 14 pivots from the retracted position shown in FIG. 4 with vertical leg 98 parallel to end wall 20. Assembly 10 is used to transfer an electrophoresis gel slab 60 from cassette 54 to carrier 62. Typically, a liquid such as distilled water or a buffer solution 100 is placed in tray 12 to a sufficient level to cover projections 46 as shown in FIG. 6. Cassette 54 is placed in buffer solution 100 at first end 28 of tray 12. The top plate 56 is gently separated from gel 60 in a manner to avoid tearing or distorting gel 60. In one embodiment, cassette 54 is immersed in buffer solution 100 or other liquid and top plate 56 is separated from gel 60 while immersed in buffer solution 100. In alternative methods, top plate 56 can be separated from gel 60 prior to immersing in buffer solution 100.

Carrier 62 is positioned in the recessed area of bottom wall 16 and second clamping jaw 66 is moved to the open position. Retaining arm 14 is then rotated to the retaining position to engage second clamping jaw 66 and retain carrier 62 in the open position as shown in FIG. 7 for receiving gel 60. Gel 60 is immersed in buffer solution 100 and is separated from bottom plate 58 of cassette 54. Gel 60 can then slide upwardly along inclined middle section 36 to position a longitudinal edge 102 between clamping surfaces 72 and 78 as shown in FIG. 8. Projections 46 provide a small surface area that contacts gel 60 to prevent gel 60 from adhering to bottom wall 16 of tray 12. Projections 46 form channels 52 between adjacent projections to supply buffer solution 100 to the bottom surface of gel 60 so that gel 60 can float and slide along bottom wall 16. Preferably, projections 46 are spaced apart a distance so that channels 52 have a width and depth to prevent gel 60 from contacting the bottom of channels 52. Gel 60 bridges peaks 50 of projections 46 and is supported by liquid in channels 50 when gel 60 contacts bottom wall 16.

Typically, tray 12 contains an amount of a liquid to cover surface 30 of bottom wall 16. The liquid serves as a lubricant to enable the gel to slide between cassette 54 and carrier 62. In further embodiments, a source of liquid can be supplied to one end of bottom wall 16 by a pump or other system in a manner to flow across the surface of bottom wall 16 and prevent the gel from adhering to the bottom wall 16.

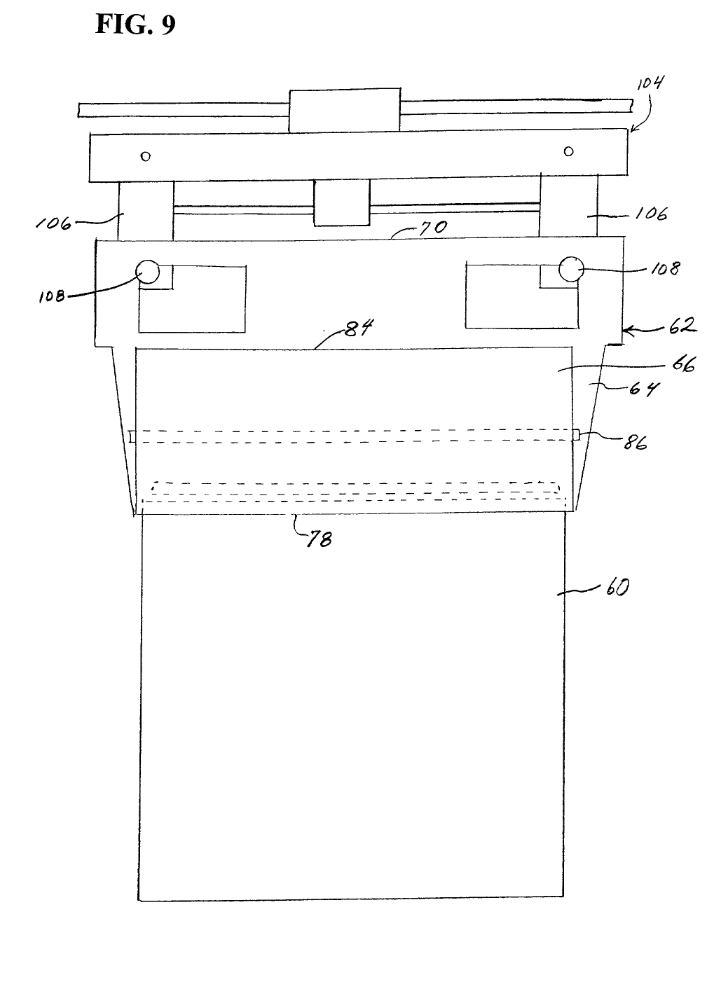

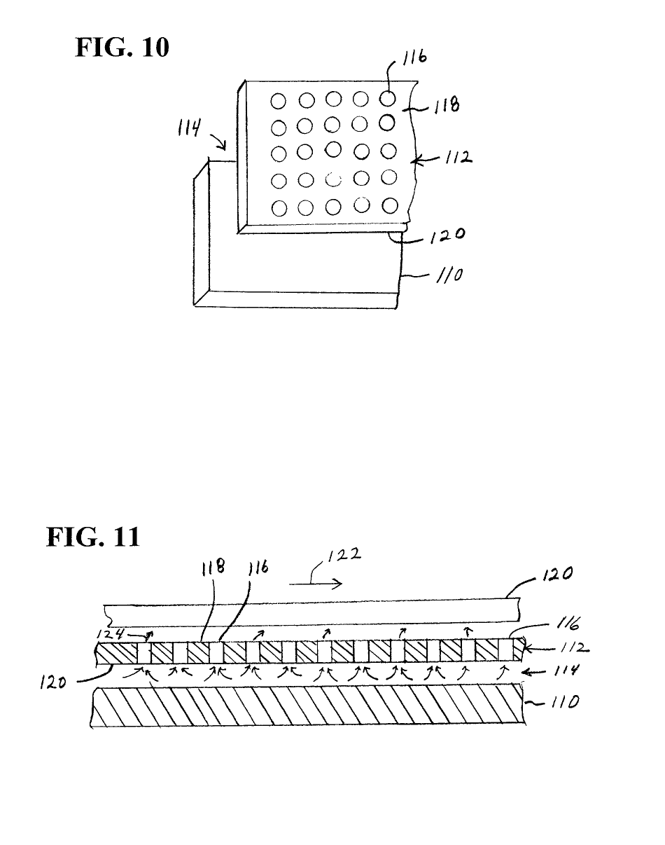

When gel 60 is positioned between clamping jaws 64 and 66, retaining arm 88 is pivoted to the retracted position to allow clamping surfaces 72 and 80 to engage gel 60. Clamping surfaces 72 and 80 grip the longitudinal end 102 of gel 60 with sufficient force so that gel 60 can be suspended vertically from carrier 62. As shown in FIG. 9, carrier 62 and gel 60 can be coupled to a robotic arm 104. Robotic arm 104 in the embodiment illustrated includes movable arms 106 having hooks 108 for coupling to carrier 62. Robotic arm 104 is adapted for manipulating and moving carrier 62 and gel 60 to various processing stations as known in the art. Robotic arm 104 is intended to be illustrative of a device for manipulating gel 60.

In another embodiment shown in FIGS. 11 and 12, the device has a bottom wall 110 and a gel support 112 spaced from bottom wall 110 to form a cavity 114 therebetween. Gel support 112 in the illustrated embodiment has a substantially plate-like structure oriented substantially parallel to bottom wall 110. Gel support 112 includes a plurality of channels 116 extending between the top surface 118 and the bottom surface 120. Channels 116 provide fluid communication between cavity 114 and top surface 118 of gel support 112. An electrophoresis gel 120 as shown in FIG. 11 can be moved along top surface 118 in the direction of arrow 122 which can draw the liquid from cavity 114 through channels 116 to top surface 118 in the direction of arrows 124 to form a liquid layer between gel 120 and gel support 112. In the embodiment illustrated, the flow of liquid through channels 116 is created by the drag of gel 120 as it moves across top surface 118 of gel support 112. Channels 116 also reduce the surface area of gel support 112 to limit the surface area that contacts gel 120. In further embodiments, a pressure source such as a pump can be provided to create a positive pressure in cavity 114 to force liquid through channels 116 and form a liquid cushion layer to support gel 120.

In the illustrated embodiments of the invention, the device is a vessel or tray having a bottom wall with a non-stick surface that prevents or inhibits the gel from adhering. In alternative embodiments, the device can be an insert having a textured surface that can be placed in an existing tray or vessel.

While various embodiments of the invention have been illustrated, it will be understood by those skilled in the art that additions and modifications can be made without departing from the scope of the invention as defined in the appended claims.

What is claimed is:

1. A tray for transferring an electrophoresis gel from a cassette to a carrier, said tray comprising:
a bottom wall having a top face with a plurality of recesses to define a surface area to limit contact of an electrophoresis gel slab with said bottom wall; and
a side wall coupled to said bottom wall for defining an interior region.

2. The tray of claim 1, wherein said tray has a first end and second end, said bottom wall has an inclined portion extending between said first end and said second end, whereby said tray has a decreasing depth from said first end to said second end.

3. The tray of claim 2, wherein said bottom wall has a first planar portion at said first end and a second planar portion at said second end, said tray having a first depth at said first end and a second depth at said second end, wherein said first depth is greater than said first depth.

4. The tray of claim 3, wherein said tray is dimensioned to contain a cassette containing an electrophoresis gel slab and said second planar portion is dimensioned to receive a carrier for manipulating said gel slab.

5. The tray of claim 4, wherein said carrier comprises a clip having first and second jaws having an operating end and gripping end, and wherein said tray includes an arm for engaging said operating end of said first jaw for retaining said gripping ends in an open position.

6. The tray of claim 5, wherein said arm is disposed at said second end of said tray.

7. The tray of claim 6, wherein said arm is pivotally coupled to said wall and is movable between a retracted position and an operating position.

8. The tray of claim 7, wherein said arm is pivotal about an axis oriented substantially perpendicular to said second portion of said bottom wall.

9. The tray of claim 8, wherein said arm is pivotally coupled to said side wall.

10. The tray of claim 1, further comprising a plurality of projections, said projections being spaced apart a distance to define said recesses.

11. The tray of claim 1, wherein said recesses define fluid channels in said bottom wall, said tray further comprising a plurality of projections spaced apart a distance to define said channels between adjacent projections, said channels having a dimension to contain a volume of liquid sufficient to prevent a gel slab from adhering to said bottom wall.

12. The tray of claim 10, wherein said projections have a substantially pyramid shape.

13. The tray of claim 10, wherein said projections comprise a plurality of spaced-apart ridges.

14. The tray of claim 10, wherein said projections are spaced apart a distance and have a height sufficient to prevent an electrophoresis gel from contacting and adhering to a bottom surface of said recess.

15. An apparatus for manipulating an electrophoresis gel slab, said apparatus comprising:
a vessel having a bottom wall and a side wall, said vessel having a dimension to receive an electrophoresis gel slab;
a clamp assembly having a pair of movable jaws, each jaw having an operating end and a gripping end, said gripping ends being biased toward each other, said clamp assembly being dimensioned to fit in said vessel; and
a retaining arm for engaging said clamp assembly positioned in said vessel and for retaining said clamp assembly in an open position.

16. The apparatus of claim 15, wherein said bottom wall includes a plurality of projections having a surface area sufficient to prevent said gel slab from adhering to said bottom wall.

17. The apparatus of claim 15, wherein said bottom wall includes a plurality of spaced-apart projections defining a plurality of recesses, said projections having a height sufficient to prevent said gel slab from adhering to a bottom portion of said recesses.

18. The apparatus of claim 17, wherein said projections have a substantially semi-spherical shape.

19. The apparatus of claim 17, wherein said projections have a substantially pyramid shape.

20. The apparatus of claim 17, wherein said projections comprise a plurality of ridges.

21. The apparatus of claim 15, wherein said vessel includes a first end and a second end and said bottom wall includes an inclined portion extending between said first end and said second end.

22. The apparatus of claim 21, wherein said vessel includes a first substantially planar portion at said first end and a second substantially planar portion at said second end, said first planar portion defining a first depth of said vessel and said second planar portion defining a second depth of said vessel, wherein said first depth is greater than said second depth.

23. The apparatus of claim 22, wherein said second portion is dimensioned to support said clamp assembly and wherein said retaining arm is disposed at said second end of said vessel.

24. The apparatus of claim 23, wherein said retaining arm is coupled to said side wall of said vessel.

25. The apparatus of claim 24, wherein said retaining arm is pivotably coupled to said side wall.

26. The apparatus of claim 25, wherein said retaining arm pivots about an axis substantially perpendicular to said bottom wall.

27. The apparatus of claim 15, wherein said movable jaws are pivotable with respect to each other about a pivot point disposed between said gripping end and said operating end.

28. The apparatus of claim 27, wherein said gripping ends of said jaws each include a magnet for biasing said gripping ends together.

29. A method of transferring an electrophoresis gel from a cassette to a carrier, said method comprising the steps of:
positioning an electrophoresis gel cassette on a support surface having a plurality of projections spaced apart a distance to prevent said electrophoresis gel from adhering to said support surface;
placing a carrier on said support surface proximate said cassette; and
transferring said electrophoresis gel from said cassette to said carrier and coupling said gel to said carrier.

30. The method of claim 29, comprising immersing said cassette in a liquid bath, and sliding said gel slab through said liquid to said carrier.

31. The method of claim 29, wherein said carrier comprises a clamp assembly, said clamp assembly including a pair of movable jaws having a gripping end and an operating end, said method comprising locking said jaws in an open position, transferring said gel slab to said gripping ends of said jaws and closing said gripping end onto an edge of said gel slab.

32. The method of claim 31, wherein said support surface is a tray having a dimension to contain said gel and said carrier.

33. The method of claim 32, comprising the step of providing a liquid in said tray.

34. The method of claim 32, wherein said tray comprises a movable retaining arm, said method comprising moving said retaining arm to a retaining position and retaining said clamp assembly in an open position.

35. The method of claim 34, comprising moving said retaining arm to a retracted position to close said gripping ends onto said electrophoresis gel.

36. The method of claim 34, comprising sliding said gel slab from said cassette to said gripping ends of said jaws.

37. The method of claim 29, wherein said carrier is immersed in a liquid.

38. The method of claim 29, wherein said projections extend from said bottom wall a distance to prevent said electrophoresis gel from adhering to said bottom wall.

39. The method of claim 29, wherein said projections have a substantially semi-spherical shape.

40. The method of claim 29, wherein said projections have a substantially pyramid shape.

41. The method of claim 29, wherein said projections comprise a plurality of spaced-apart ridges.
